(19) United States
(12) Patent Application Publication
(10) Pub. No.: US 2004/0172326 A1
(43) Pub. Date: Sep. 2, 2004

(54) Display system

(76) Inventors: David Yeo, Singapore (SG); Colin Theseira, Singapore (SG); Dinesh Tripathi, Singapore (SG)

Correspondence Address: FOLEY & LARDNER, 321 NORTH CLARK STREET, SUITE 2800, CHICAGO, IL, 60610-4764, US

(21) Appl. No.: 10/476,378

(22) PCT Filed: Apr. 22, 2002
(86) PCT No.: PCT/SG02/00066

(30) Foreign Application Priority Data
Apr. 23, 2001 (AU) PR 4546

(51) Int. Cl. G06F 17/60

(52) U.S. Cl. 705/14

(57) ABSTRACT

The present invention relates to a system for displaying information, such as advertising, at a remote site. The system includes a display system positioned at the remote site (3). The display system is formed from a number of displays (23-1 . . . 23-n) adapted for wireless communication with an end station (21). The display system is adapted to communicate with base station (1) that includes an input for receiving display data representing the information to be displayed and, a controller (11) for controlling the display of the information. The base station (1) and displays systems operate by communicating via a communications system (2) so as to allow the display data to be transferred from the base station (1) to the display system. The display system then operates to display the information as required by the controller (11).

### BACKGROUND OF THE INVENTION

The present invention relates to a system for displaying information at a remote site and in particular, to a wireless display system for displaying advertising or the like.

### DESCRIPTION OF THE PRIOR ART

The reference to any prior art in this specification is not, and should not be taken as an acknowledgment or any form of suggestion that the prior art forms part of the common general knowledge in Australia, or throughout the world.

It is well known in the advertising industry that the most effective adverts are those made at the point of sale (ie advertising a product at a location where the product is available for sale). A number of techniques for providing advertising at the point of sale currently exist.

The most basic technique for example, is to provide display space stands incorporating advertising with the product being located on the display stands. In addition to this, the use of posters and the like to advertise products is well known.

However, static pictures are only of limited interest to consumers and accordingly, in recent years, the use of moving images has increased. These usually take the form of television or computer screens which are used to display advertising in, for example supermarkets. However, these systems currently require the television sets or computer screens to be wired into position.

This in turn results in a number of additional problems. In particular, the wired systems are immobile and inflexible which means they cannot be shifted from one location to another within the supermarket. Accordingly, if adverts are to be displayed at different locations within a supermarket, it is necessary to have separate screens at each location, even if these are not in use all the time.

In addition to this, the process of installing a system typically requires the installation of wiring as well as the television or display screens themselves, making these systems costly to install and maintain.

As a result, previous solutions to implement moving displays or adverts at the point of sale have always been prohibitively expensive due to the cost in the initial system set-up.

WO91/17530 describes a method and apparatus for displaying advertisements and printing coupons at a device such as a vending machine. The system operates by having a central system generate schedules defining the display of the adverts, with these schedules being downloaded to the vending machines to cause adverts to be displayed as desired.

U.S. Pat. No. 5,797,757 describes a portable display for use in shops. The display allows shopping lists, and product information to be displayed to the user. Accordingly, in this system, the user must log on to a respective display so that the information displayed is directed to that user.

### SUMMARY OF THE PRESENT INVENTION

In a first broad form the present invention provides a system for displaying information at a remote site, the system including:

a) A display system positioned at the remote site, the display system including:

i) An end station; and,

ii) A number of displays, the number of displays being adapted for wireless communication with the end station;

b) A base station including:

i) An input for receiving display data representing the information to be displayed; and,

ii) A controller for controlling the display of the information; and,

c) A communications system for transferring the display data from the base station to the display system, the display system being adapted to display the information as required by the controller.

Typically each display includes:

a) A display store for storing display data;

b) A screen; and,

c) A display processor, the display processor being adapted to cause the screen to display the information represented by the display data.

The end station usually includes:

a) An end station store for storing display data received from the base station; and,

b) An end station processor, the end station processor being adapted to control the transfer of the display data to the displays.

The information usually has one of a number of different types, the information type being indicated in the corresponding display data. In the case of adverts, this information type may be for example an indication of the type of product being advertised. Alternatively, or additionally, the information type may indicate whether the information is to be displayed on selected or many of the screens at a remote location.

The controller preferably includes:

a) A control store for storing location data, the location data indicating a location for each display at the remote site; and,

b) A control processor, the control processor being adapted to:

i) Determine the information type of the respective information to be displayed;

ii) Determine the location in which the respective information is to be displayed, the location being determined in accordance with the information type;

iii) Schedule the display of the respective information at the respective location; and,

iv) Transfer the corresponding display data to the display system.

Generally, the display system is adapted to maintain a schedule for each location, the display system being adapted to display the respective information in accordance with the respective schedule.

The control processor is preferably adapted to transfer the schedules to the display system by transferring commands, each command indicating the time and the location(s) at which the respective information is to be displayed. Alternatively, the entire schedule could be transferred each time it is altered, although this would usually result in a vast increase in the amount of data that would need to be transferred from the controller to the display system.

Typically at least some of the displays are statically positioned at the remote location, each static display being adapted to maintain a respective schedule.

In this case the end station may be adapted to transfer the commands to the static display(s) in accordance with the display location(s), the display processor of each static display being responsive to the commands to maintain the respective schedule.

If the display data is broadcast data adapted to be broadcast from the end station, then the end station processor is preferably adapted to:

a) Maintain a broadcast schedule for each location, the broadcast schedule indicating the time at which the respective information is to be displayed; and,

b) Transfer the broadcast data to one or more of the displays positioned in the respective location in accordance with the respective schedule.

The end station processor typically maintains the broadcast schedules by:

a) Determining the commands which relate to information for which the corresponding display data is broadcast data; and,

b) Either updating existing broadcast schedules or generating new broadcast schedules.

The display processors are usually adapted to:

a) Receive the broadcast data; and,

b) Cause the corresponding respective information to be displayed on the screen in accordance with the respective schedule.

The display processors are usually also adapted to maintain a schedule by:

a) Receiving the commands; and,

b) Either updating existing schedules or generating new schedules.

Alternatively, if the display data is download data adapted to be downloaded from the end station prior to display, the display processor is generally adapted to maintain the respective schedule by:

i) Receiving the commands;

ii) Determining the respective information to which the command refers;

iii) Determining if the display data corresponding to the respective information is stored in the display store; and,

iv) Either updating existing schedules or generating new schedules in response to a successful determination.

In response to an unsuccessful determination the display processor typically generates a request for the corresponding display data, the end station being responsive to the request to transfer the corresponding display data to the display store.

In this case the display processor usually either updates existing schedules or generates new schedules upon receipt of the corresponding display data.

At least some of the displays are usually dynamically positioned at the remote location, each dynamic display being moved between different locations in use.

In this case, the end station processor is preferably adapted to:

a) Receive the commands;

b) Maintain a schedule for each location in accordance with the received commands;

c) Determine the current location of each dynamic display; and,

d) Transfer display data to each dynamic display in accordance with the determined location and the respective schedule.

The input is typically further adapted to receive a time slot notification indicating when the respective information is to be displayed. This allows the controller to schedule the display of the respective information in accordance with the time slot notification.

The information usually includes adverts, with the information type indicating the type of product being advertised. In the case the location data specifies the types of products near which the display is located.

The display processors are preferably adapted to display data having any one of a number of different formats, such as:

a) Video;

b) Audio;

c) Graphics;

d) Multimedia; and,

e) Text.

In this case, the multimedia files may include any one of a number of different types of data, such as flash, avi (audio-visual), mov (movie), mpeg-I, mpeg-II, powerpoint, or the like.

The base station is usually adapted to encrypt and/or compress the display data prior to transfer to the display system, the end station being adapted to decrypt and/or decompress the display data as it is received.

The base station also usually includes a billing system, the billing system being adapted to generate a bill for displaying the information.

In this case each display preferably generates confirmation data confirming the display of the respective information, the confirmation data being used by the billing system to generate the bills.

The communications system includes a communications network which interconnects the end station and the base station. This may be any form of communications network which is capable of transferring data between two separate locations. Thus the network could be a public network, such as the Internet, or a private network, such as a LAN (Local Area Network), a WAN (Wide Area Network), or the like. Furthermore, the network may be wired or wireless.

Typically, the communications network will be the Internet, with a base station and remote sites being coupled to the Internet via ISDN or leased lines, as this provides a high data transfer bandwidth. Alternatively however, the base station and remote sites may be interconnected via a telephone line connection made over a PSTN (Public Switched Telephone Network). This allows the system to be integrated into existing locations without the need to install wiring or the like.

In a second broad form the present invention provides a display for displaying information provided by an end station, the display including:

a) A transceiver for providing wireless communication with the end station, the transceiver being adapted to receive:

i) Display data representing the information to be displayed; and,

ii) An indication of the time at which the respective information is to be displayed;

b) A display store for storing display data;

c) A screen; and,

d) A display processor adapted to cause the screen to display the respective information at the indicated time.

The display will also typically include a sound systems, the display processor being adapted to cause the sound system to generate sound so as to display the respective information.

The display typically includes a timer, the display processor being responsive to the timer to display the respective information at the indicated time.

If the display data is broadcast data adapted to be broadcast from the end station, the display processor is adapted to display the respective information as the broadcast data is received.

As a further option the display may include an input, the display data representing interactive information, the display processor causing the display data to interact in response to commands received at the input. The input would normally be formed from a touch sensitive screen, or the like, although a separate keyboard, mouse or the like may be used.

In a third broad form the present invention provides an end station for use in a display system, the display system being adapted to display information at a remote location, the end station including:

a) An input for receiving:

i) Display data representing the information to be displayed; and,

ii) An indication of the time and location at which the respective information is to be displayed; and,

b) An end station store for storing display data; and,

c) An end station processor, the end station processor being adapted to control the transfer of the display data to one or more of a number of displays, the respective information being displayed on the displays.

The end station processor is typically adapted to transfer the display data to the displays via a transceiver.

In the case in which dynamic displays are used, the end station is preferably adapted to determine the location of each display. This process may also be performed with static displays to determine the display locations when the system is initially configured at a remote site.

The location is usually determined by having the end station coupled via the transceiver to at least two antennas, the end station processor being adapted to determine the location of each display in accordance with signals received from the respective display, via each antenna.

In a fourth broad form a display system for displaying information at a remote location, the display system including:

a) An end station including:

i) An input for receiving:

(1) Display data representing the information to be displayed; and,

(2) An indication of the time and location at which the respective information is to be displayed; and,

ii) An end station store for storing display data; and,

iii) An end station processor, the end station processor being adapted to control the transfer of the display data to the displays.

b) A number of displays, each display including:

iv) A display store for storing the display data;

v) A screen; and,

vi) A processor adapted to cause the screen to display the information represented by the display data; and,

c) A wireless communications system for interconnecting the end station and each display.

The wireless communications system usually includes:

a) A transceiver coupled to the end station; and,

b) Respective display transceivers located in each display.

In the fourth broad form of the invention, the display is typically a display according to the second broad form of the present invention with-the end station typically being an end station according to the third broad form.

In a fifth broad form the present invention provides a base station for receiving information to be displayed on a display system at a remote location, the base station including:

a) An input for receiving display data representing the information to be displayed;

b) A controller for controlling the display of the information; and,

c) An output for transferring the data and the schedule to the remote location.

The input is usually coupled to a communications network, the input being adapted to receive the display data in an electronic format.

It will be realised from the above that the first broad from of the present invention may be implemented using any of the second, third, fourth or fifth broad forms of the present invention.

Finally the present invention also provides computer program products for causing displays, end stations and base stations to operate in accordance with second, third and fifth broad forms of the invention respectively.

### BRIEF DESCRIPTION OF THE DRAWINGS

Examples of the present invention will now be described with reference to the accompanying drawings in which:-

FIG. 1 is a schematic diagram showing a system for displaying advertising;

FIG. 2 is a schematic diagram of one of the controllers of FIG. 1;

FIG. 3 is a schematic diagram of the server of FIG. 1;

FIG. 4 is a schematic diagram of one of the end stations shown in FIG. 1;

FIG. 5 is a schematic diagram of one of the displays shown in FIG. 1;

FIGS. 6A, 6B and 6C are flow diagrams showing the operation of the base station, the end station and the displays to schedule adverts for display;

FIGS. 7A and 7B are flow diagrams showing the operation of the end station and the displays for static display operation; and,

FIGS. 8A and 8B are flow diagrams showing the operation of the end station and the displays for the dynamic displays.

### DETAILED DESCRIPTION OF THE PREFERRED EMBODIMENTS

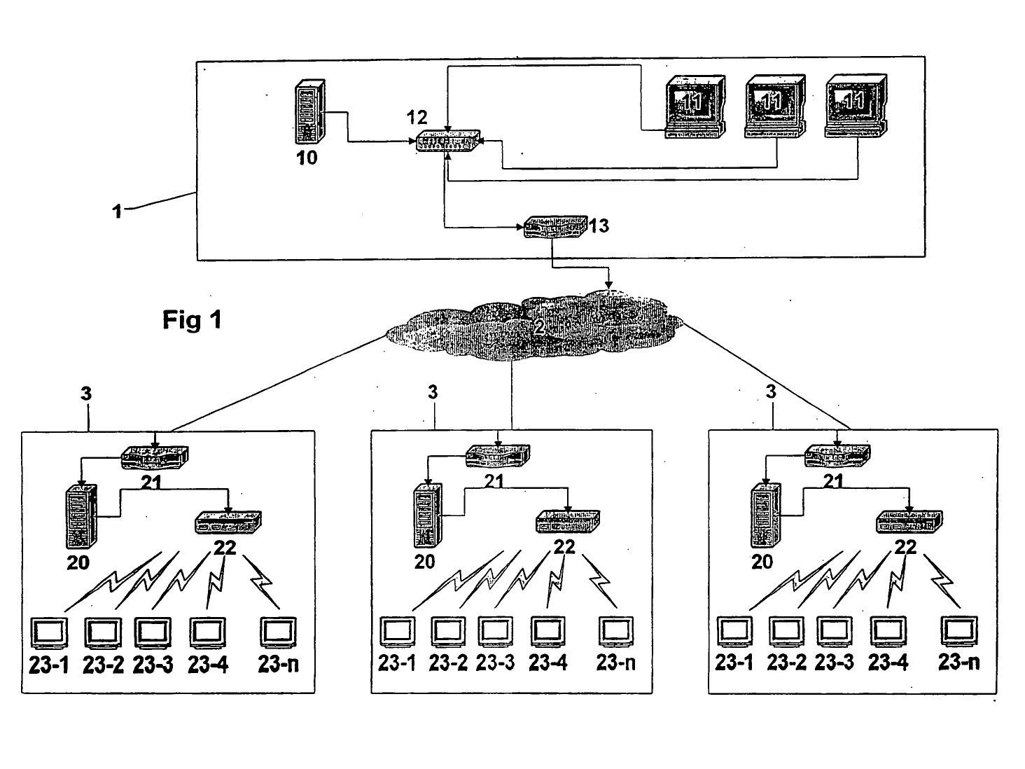

FIG. 1 shows a system for displaying adverts in accordance with the present invention.

The system includes a base station 1 coupled to a number of remote locations 3 via a communications network 2. This communications network may consist of any suitable communications network, such as a LAN, a WAN, or the like. Accordingly, the communications network may be a wired or wireless network and in this example will be taken to be the Internet Alternatively however the base station 1 may be coupled to the remote sites via telephone connections established via a PSTN.

In use, the base station 1 operates to receive data representing adverts to be displayed at the remote locations 3. The base station 1 operates to schedule the display of the adverts before transferring the adverts to the remote locations 3 for subsequent display.

As shown in FIG. 1, the base station 1 includes a server 10 coupled to a number of controllers 11 via a switch 12. The switch 12 is in turn coupled to the communications network 2 via a router 13.

It will be appreciated by a person skilled in the art that whilst the present example describes the use of a switch 12 alternatively a communications network, such as a LAN could be used.

Similarly, the remote sites 3 each include an end station 20 coupled to the communications network 2 via a router 21. The end station 20 is also coupled to a number of displays 23-1, 23-2, 23-3, 23-4, . . . 23-n via a radio transceiver 22 as shown.

Accordingly, once adverts have been scheduled for display by the base station 1 the adverts are transferred to the end station 20 of the respective remote site 3 for subsequent transfer to the displays 23. The adverts can then be displayed on the displays in accordance with schedule determined by the base station.

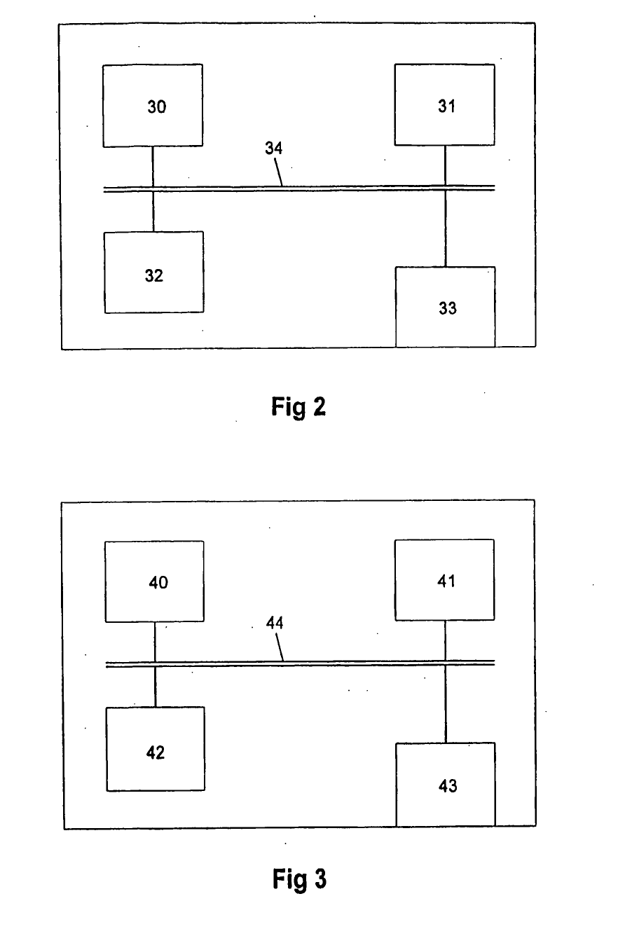

An example of one of these controllers 11 is shown in more detail in FIG. 2. As shown, the controller 11 is formed from a processing system including a processor 30, a memory 31, an input/output (I/O) device 32 and an interface 33 coupled together via a bus 34. The interface 33, which may be a network interface card, or the like, is used to couple the controller 11 to the switch 12, thereby allowing the controller 11 to receive data via the communications network 2.

Accordingly, it will be appreciated that the controller may be formed from any suitable processing system, such as a suitably programmed PC, Internet terminal, lap-top, hand-held PC, or the like.

In use, the controllers 11 operate to receive display data representing adverts to be displayed. The controllers 11 then operate to schedule when and where the adverts should be displayed, before transferring the display data to the server 10, together with an indication of the determined schedule, as will be explained in more detail below.

The display data may be received in an electronic format from advertisers via the communications network 2, the router 13 and the switch 12. Thus, advertisers can for example e-mail in the adverts which are to be displayed using the system. As will be explained below, the advert may be provided in any format, such as video and/or audio data, or in a computer format such as flash, shockwave, MPEG, or the like.

Alternatively however, the display data may be obtained by other means, such as via manual input using the I/O device 32. In this case, the advertiser may provide a hard copy of an advert to be displayed, or simply provide an oral indication for example by telephone. In this case, the display data would then be generated by a user of one of the controllers 11 using the respective I/O device 32.

In addition to defining the adverts to be displayed, the display data also typically includes an indication of the advert type, together with a time slot notification indicating a time period during which the advert is to be displayed.

In addition to the features outlined above, the controllers 11 also incorporate applications software for billing the advertisers and for controlling the operation of the local network, as will be explained in more detail below.

An example, of the base station server 10 is shown in more detail in FIG. 3. As shown, the server 10 includes a processor 40 coupled to a memory 41, an I/O device 42, an interface 43, and a timer 46, via a bus 44. Accordingly, the server 10 may be any form of processing system, and in particular any form of suitably programmed network server.

In use, the server 10 executes applications software designed to manage the overall operation of the base station 1 and the remote sites 3. In particular the server 10 is adapted to oversee the transmission and control of the data, the operation of the remote sites 3 and the displays 23, as well as acting as a time server to synchronise the operation of the remote sites 3 and the base station 1.

In addition to this, the server 10 provides encryption and compression capabilities for encrypting and compressing data which is to be transferred via the communications network 2.

It will be realised from the above that the server 10 and the controller 11 are both processing systems which execute appropriate applications software. Accordingly, the server 10 and the controller 11 can be replaced by a single processing system adapted to provide the functionality of the server 10 and the controller 11. This would typically be achieved by having the server 10 execute applications software to perform the function of the controllers 11.

In general however separate processing systems are used to allow large volumes of display data to be rapidly processed by the system.

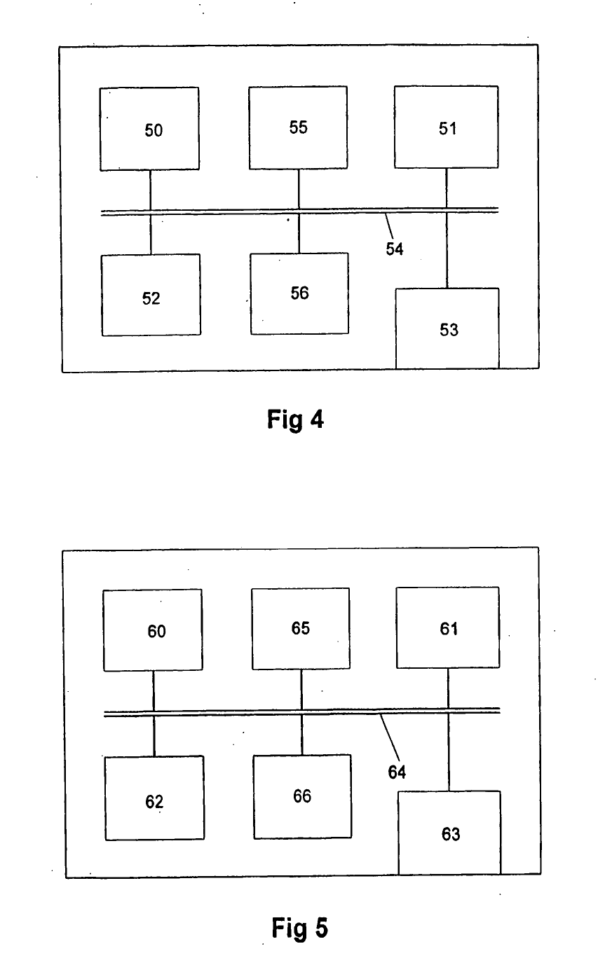

An end station 20 from one of the remote locations 3 is shown in more detail in FIG. 4. As shown, the end station 20 includes a processor 50 coupled to a memory 51 and an I/O device 52 via a bus 54. Also coupled to the bus 54 is a network interface 53 for connecting the end station 20 to the router 21, and a transceiver interface 55 for connecting the end station to the displays 23, via the transceiver 23.

Finally a timer 56 is also provided for controlling the timing of operations performed by the end station. In order to function correctly, the end timer 56 is synchronised with the timer 46 of the server 10 using the SNTP protocol.

In use, the end station 20 operates to receive display data and scheduling information from the base station 1. The end station 20 then controls the transfer of the display data and the scheduling information to the displays 23 to ensure that adverts are displayed as required.

An example of one of the displays is shown in more detail in FIG. 5. As shown, the displays comprise of a processor 60 coupled to a memory 61 a screen 62, an input device 63 and a transceiver 65 via a bus 64. Again a timer 66 synchronised with the server timer 46 is also provided to control the timing of the advert display.

Again, it will be appreciated that as the end station 20 and the displays 23 are processing systems, then the functionality of the two devices can be combined in a single processing device. In this case, the display 23 would perform the functionality of the end station 20, with the display being wirelessly coupled to the routers 21 via a wireless access point.

In use, the displays operate to receive display data and scheduling information transferred as RF (radio frequency) signals wirelessly from the end station 20 via the transceiver 65. This is achieved by assigning a respective identifier to each display. Any data transmitted to the displays then includes the respective display identifier of each display which is to receive the data When data is transmitted, the transmission of the data is detected by each of the displays which operates to check the display identifiers included within the data. If the display identifiers correspond to the display identifier of the respective display, then the data is received, otherwise the data is simply ignored.

This allows communications to be achieved between an end station and a large number of displays, without having to communicate with each display using a respective frequency. This vastly reduces the complexity of the apparatus, as well as allowing a single frequency band to be used.

In this example, the system uses the ISM band and uses 2485 MHz (2.4 GHz) frequency for the RF communication as this frequency is free from licensing allowing the system to be used worldwide without any licensing issues.

This frequency is capable of providing data communication at speeds varying between 1-Mbps to 11-Mbps, which in turn allows the transmission and reception of real-time video signals.

In order for the system to function correctly, the radio transceiver 22 and the displays 23 preferably use high gain antennas for capturing signals. The antennas are designed for indoor use to ensure high-speed reception of data signals. The antennas generally have-high gain, low power consumption, a small size, are omni directional, have built in error-correction and noise reduction/elimination. However, other antennas can also be used in the system with little compromise to quality.

The information received by the displays is used by the processor 60 to display information as required by the scheduling.

It will be appreciated from the above that by positioning the radio transceiver 22 and the devices 23 at a remote location, such as inside a supermarket, this allows adverts to be displayed at the point of sale for certain products.

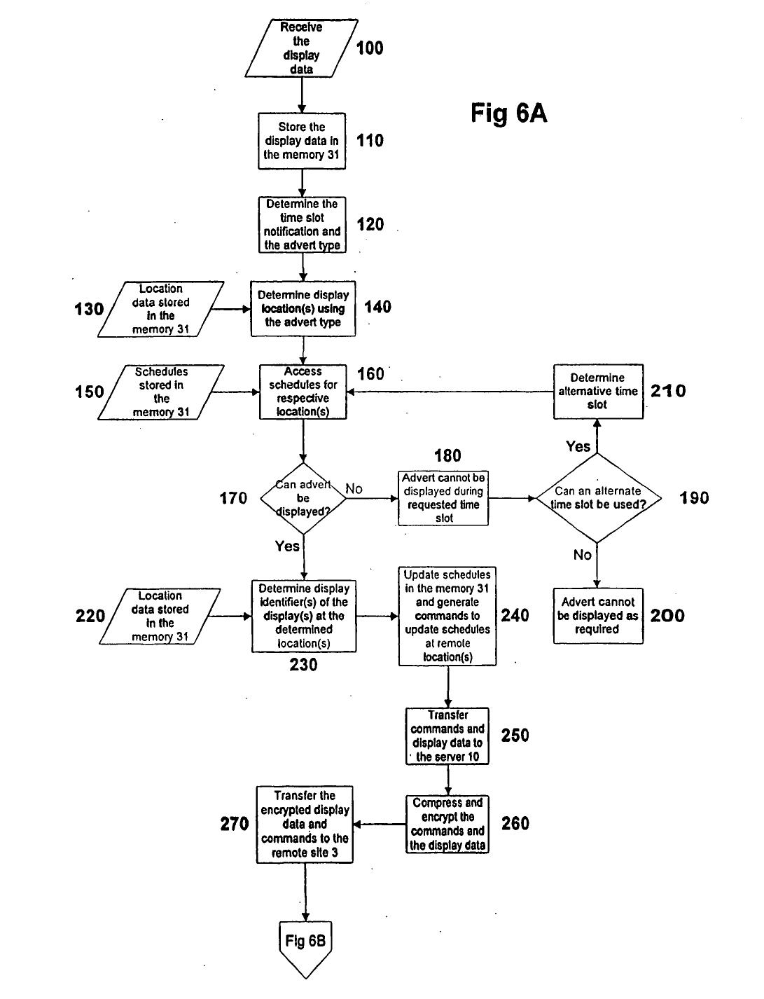

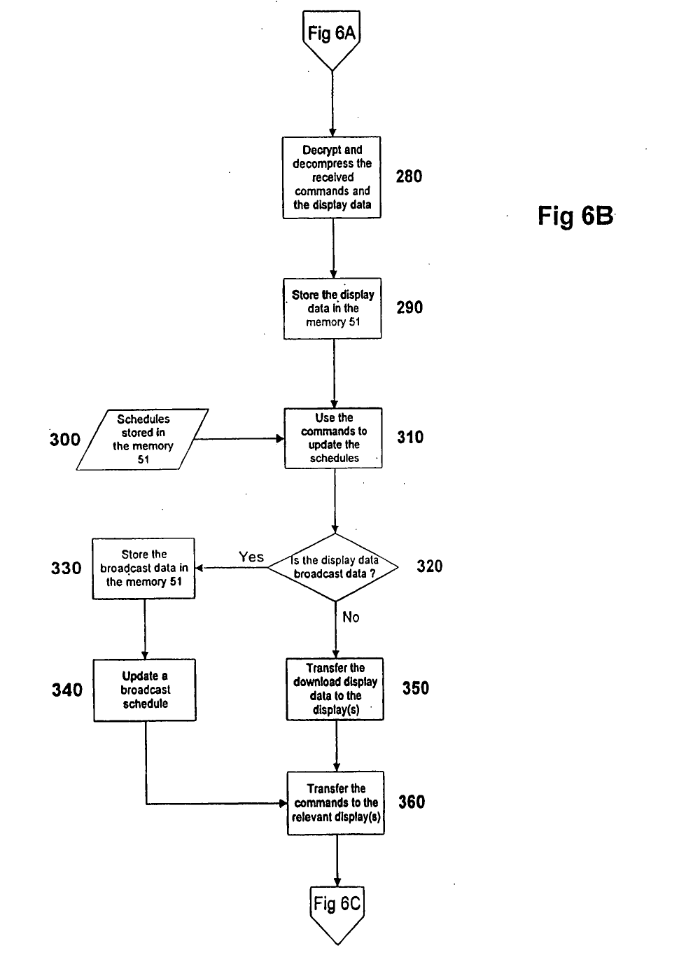

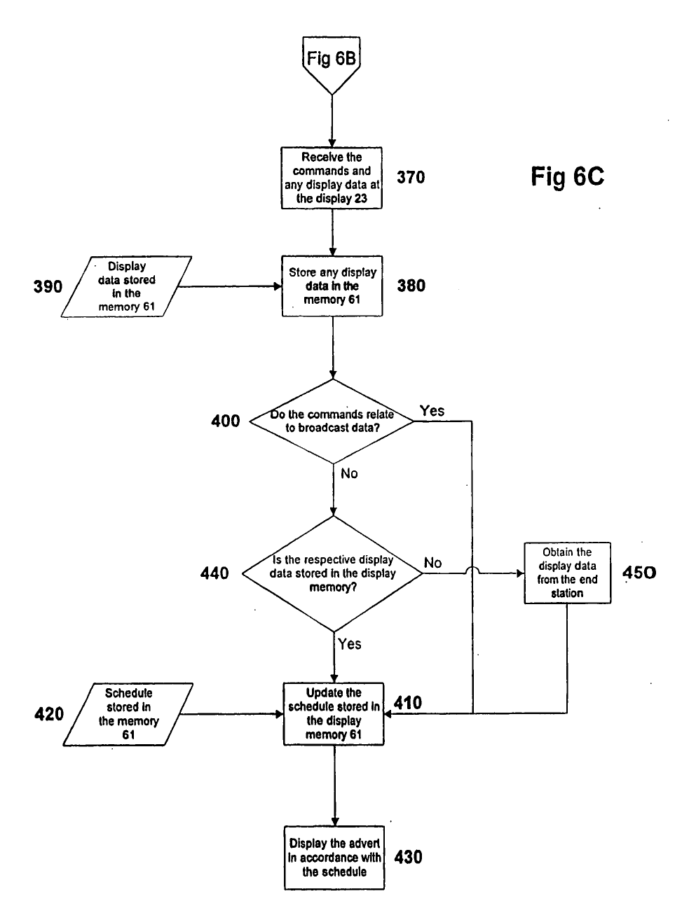

Operation of the entire system will now be described in more detail with respect to the flow diagrams shown in FIGS. 6, 7, and 8.

The present examples will be described with reference to advertising in supermarkets, although it will be appreciated that the system may also be utilised for advertising any form of information. Thus, for example, the system can be advantageously used to provide product information at exhibitions, as well as timing information at conferences, or the like.

Operation of the system to schedule the display of an advert will now be described with respect to FIGS. 6A, 6B and 6C.

Initially, as described briefly above, the controllers 11 operate to receive display data at step 100. This display data defines the advert, as well as including an indication of the advert type, and a time slot notification indicating a time period during which the advert can be displayed.

It will be appreciated that this display data may be received in electronic format via the communications network 2 or on a data carrying medium such as a CD rom, floppy disk or the like. Alternatively, the display data may be provided in a hard coded form such as by fax, or in oral form such as via a telephone conversation. This information would then be converted into an electronic format via input using the I/O device 32.

Once received, the display data is temporarily stored in the memory 31 whilst the processor 30 operates to determine the time slot when the advert can be displayed together with the advert type, as shown by steps 110 and 120 respectively.

It will be appreciated that if the display data is not an electronic format then the step of determining the time slot notification and the advert type is typically achieved by having this data entered by the user of the controller 11 via the I/O device 32. In particular, it may be necessary for a user of one of the controllers 11 to view the advert in order to determine the advert type, if an advert type indication is not included as separate information within the display data.

Once this has been achieved, the processor 30 operates to access location data stored in the memory 31 as shown at 130. The location data indicates a list of possible locations at the respective remote site 3. For each possible location the location data indicates the type of product on offer in that location, together with display identifiers which uniquely ide4ntify each of the displays positioned at that respective location.

It will be appreciated that the location data will need to be determined when the remote site is initially set up. In particular, whilst the location of the displays relative to the end station 20 can be determined automatically (as will be described below), it is necessary for information regarding the products on offer in different locations to be determined manually when the system is installed into the supermarket.

This procedure will typically involve subdividing the supermarket into a number of zones according to the category of products sold in each zone. Thus for example, the supermarket may be divided into zones covering fruits and vegetable, dairy produce, frozen foods, household products, drinks, and the like. The location of these zones can then be mapped so that as the location of each display is determined, the zone in which the display is located can be determined.

This information is then used to generate the location data by storing an indication of the display identifiers of each of the displays located in a respective zone, together with an indication of the type of products sold in the zone, for each zone. This in turn allows each display within a respective zone to be determined by the processor 30, of the controllers 11.

Accordingly, once the processor 30 has determined the advert type, and hence which product the advert relates to, the processor accesses the location data to determine in which zone the advert should be displayed. The processor can then determine the displays identifiers of each of the displays 23 located within the respective zone.

Thus for example, if the advert is for milk the advert type will typically indicate dairy products or the like. The processor 30 will then determine within which zone(s) dairy products are displayed. From this, the processor 30 can determine which displays are located near where milk is displayed, thereby allowing the milk advert to be displayed to the target audience (ie. potential purchasers of milk).

It will be appreciated that if the advert type indicates the type of product in specific terms (ie. milk), the location data is adapted to allow processor 30 to determine which products fall within which categories, thereby allowing the processor to determine within which zones the advert should be displayed.

Alternatively, the advert type could indicate the category of product allowing a direct correspondence between the zones in the supermarket and the advert type to be used. Furthermore, the advert type could correspond to a number of different categories indicating that the advert is to be displayed at a number of different zones within the supermarket. Thus for example, the advert type “all” indicates that the advert is to be displayed in all locations at the remote site.

Having determined one or more locations at which the advert can be displayed the processor 30 operates to access schedules which are stored in the memory 31. A respective schedule is provided for each of the locations within the supermarket, allowing the processor to determine which adverts are currently due to be shown and when for each location, as shown at steps 150 and 160.

The present example has been described for the situation in which the locations are divided according to the different zones within the supermarket, such that each location corresponds to a respective zone. This example is being described for the sake of simplicity of description, although it will be appreciated that the system could also be adapted to control the display of adverts at different positions within each zone. Accordingly, if a zone contains multiple displays, each display can display different adverts. In this case, the location data would need to identify the exact position of each advert, and similarly, different schedules would need to be provided for each position.

Once the schedules for the respective location(s) have been accessed, the processor 30 then operates to compare the time slot notification determined from the display data to the respective schedules to see if adverts can be displayed at the desired time, as shown at step 170.

Thus for example, the time slot notification may indicate that a milk advert is to be displayed at 4:00pm. However, if the respective schedule for the dairy product location(s) are full at 4:00pm then it will not be possible for the controller to schedule the advert, as shown at step 180.

At this point, the processor 30 operates to determine whether the advert can be scheduled for display at an alternative time at step 190. Thus for example, the time slot may indicate that the advert can be displayed at any time between 4:00pm and 4:30pm. In this case, the schedule may indicate that the advert can be displayed at 4:15pm and the processor 30 will schedule the advert accordingly.

Furthermore, the display data may be provided with alternative time slots which can be used if the preferred time slot is unavailable. Alternatively the advertiser could be requested to indicate an alternative time slots when the original time slots can not be used. Thus, this may be achieved by having the controller 11 transfer an e-mail to the advertiser indicating that the time slot is not available with a reply e-mail being used to indicate an alternative time slot.

In this case, the processor 30 returns to step 160 to try and reschedule the advert.

If the original and any alternative time slots cannot be used then the advert cannot be displayed as required and an indication of this will typically be communicated back to the advertiser at step 200. Thus for example the controller 11 may be adapted to indicate to the advertiser that the desired time slot is not available. In this case the advert will not be displayed.

Once the display of the advert has been scheduled, the processor 30 operates to access the location data stored in the memory 31 at step 220. The processor uses this data to determine the display identifiers of each display at the determined location(s) at step 230.

The processor 30 then operates to update the schedules stored in the memory 31 for the respective locations at which the advert is to be displayed. Thus, for example, in the case of the milk advert the processor 30 would update each schedule for the dairy product locations. Once the schedules in the memory 31 have been updated the processor 30 then operates to generate commands which are used to update schedules at the remote locations.

It will be appreciated by a person skilled in the art, that each time a schedule is updated a copy of the updated schedule may be transferred from the controller 11 via the communications network 2 to the relevant remote sites 3. However, as the schedules may schedule the display of several tens of adverts in one day, then the schedules tend to be quite large in size. Accordingly, transferring a schedule each time it is updated would be extremely inefficient.

Accordingly, the processor 30 merely generates update commands that are used to modify the schedules at the remote locations. The update commands would typically include instructions such as add new advert, remove advert, or the like to cause the schedules to updated as required. Accordingly, the commands are used to modify existing schedules so that schedules maintained at the remote locations reflect those determined by the controllers 11.

The commands typically contain information about the advert to be displayed, such as any relevant file-name, file-size, file-type, file-duration, time/date of execution etc, together with the display identifiers of each display at the respective locations.

At step 250, the processor 30 operates to cause the commands and the display data stored in the memory 31 to be transferred to the server 10. This occurs every time a new advert is scheduled.

As shown at step 260, the data is then typically temporarily stored in the memory 41 at the server 10, before it is compressed and encrypted by the processor 40.

The compression is performed to reduce the volume of data which must be transferred by the communications network 2. Similarly, the encryption is performed to prevent third parties intercepting or tampering with the data being transferred.

The exact compression and encryption techniques which are used are not essential to the present invention and accordingly any suitable techniques may be used. However, the invention preferably uses a ZIP type compression algorithm, such as WVZIP, and an encryption algorithm such as a DES encryption algorithm.

It will be appreciated that as the commands typically do not have a high data volume. Accordingly, it is not essential for the commands to be compressed, although encryption of the commands will be important to ensure that the commands are not tampered with as they are transferred across the public communications network 2. Once the display data has been compressed and encrypted it can be transferred together with the commands to the remote site 3 as shown at step 270.

Turning now to FIG. 6B, this describes the operation of the remote site to schedule the data.

At step 280, the processor 50 of the end station 20 operates to receive, decrypt and decompress the commands and display data received from the base station 1. The display data is then at least temporarily stored in the memory 51 as shown at step 290.

It will be appreciated by a person skilled in the art, that the end station 20 maintains an identical copy of the schedules which are stored in the memory 31 of the controller 11. These schedules are stored in the memory 51 and are maintained by updating the schedules in accordance with any commands received from the base station 1, as shown at steps 300 and 310.

Once the schedules have been updated, the processor 50 determines whether the display data is broadcast data or download data.

Broadcast data is data which is to be broadcasted to one or more of the displays 23 directly from the end station 20. In contrast, download display data is data that will be transferred to the displays 23 from the end station 20 for storage until the respective advert is to be displayed.

Typically whether the data is broadcast data will depend on the format of the data. Thus, the broadcast data may include for example video data that is displayed by the displays 23 as it is received in real time.

However, alternative criteria could be used. For example, broadcast data may be specifically identified in the display data Alternatively, adverts which are only to be displayed once or twice may be treated as broadcast data, whereas adverts which are to be displayed several times during a predetermined time period, such as one day, may be downloaded for storage on the displays 23. The use of a download technique helps avoid repeatedly transferring the display data to the display 23 each time the advert is to be displayed. This in turn helps to reduce the amount of data that needs to be transferred between the end station 20 and the displays 23.

If the processor 50 determines the data to be broadcast data, the processor 50 will check that the broadcast data is stored in the memory 51 of the end station 20 for subsequent transfer to the displays 23, as shown at step 320. At step 340 a separate broadcast schedule is updated.

The broadcast schedule is used to indicate the times at which the end station 20 must transfer broadcast data to the displays 23 for display. The schedule will indicate not only the time at which this is to occur but will also the display identifiers of the relevant displays which are to receive the broadcast data.

If the display data is download data, then the end station processor 50 operates to transfer the display data to each of the displays as required, as shown at step 350. In order to do this, the end station processor 50 uses the display identifiers included in the commands to ensure the display data is transferred to the correct displays 23.

Once this the transfer of the download data or the storing of the broadcast data has been completed, the processor 50 operates to transfer the commands to the displays in accordance with the included display identifiers, as shown at step 360.

At this stage for reasons that will be explained in more detail below, a copy of the display data is also typically maintained in the memory 51.

The operation of the displays to schedule the display of the adverts will now be described with reference to FIG. 6C.

As shown, the displays receive the commands and any display data from the end station 20 at step 370. Any display data is stored in the memory 61, as shown at 380 and 390.

The processor 60 then operates to access the commands to update the schedules. The first stage in this process is to determine if the respective commands refer to broadcast data or download display data.

If the advert is a broadcast type advert, then as shown at steps 410 and 420 the processor 60 will operate to update the respective schedule stored in the memory 61. The display will then operate to display the advert in accordance with the schedule as will be described in more detail below.

Alternatively, if the processor 60 determines that the display data is download data, then the processor 60 will operate to check whether the respective data is yet stored in the memory 61, as shown at step 440.

If the data is not stored in the memory 61, the processor proceeds to step 450 and obtains the display data from the end station 20. Once the display data has been obtained, the processor 60 updates the schedule stored in the memory 61 in accordance with the commands, before proceeding to step 430 to display the advert in accordance with the defined schedule.

Operation of the system to display the adverts will now be described.

As previously described, the download display data is downloaded into the memory 61 of the displays 23, with the broadcast data being held in the memory 51 of the end station 20. In addition to this however, operation of the system also depends on the nature of the displays.

In particular, two types of display operation are provided for. The first type of operation is static operation in which the displays are statically positioned at the remote site. In this example statically positioned means that the position of the display is not adjusted whilst adverts are being displayed.

In contrast to this, dynamic displays are also provided, with the dynamic displays moving even whilst the adverts are being displayed. Dynamic displays may therefore be used for example as displays that are fixed to shopping trolleys, or the like, so that adverts can be displayed to the shoppers as they travel around the supermarket. In contrast to this, the static displays would typically be located in the isles of a supermarket.

The operation of the end station 20 and the displays 23 differs depending on whether the displays are static or dynamic and accordingly, each of these modes will now be described separately.

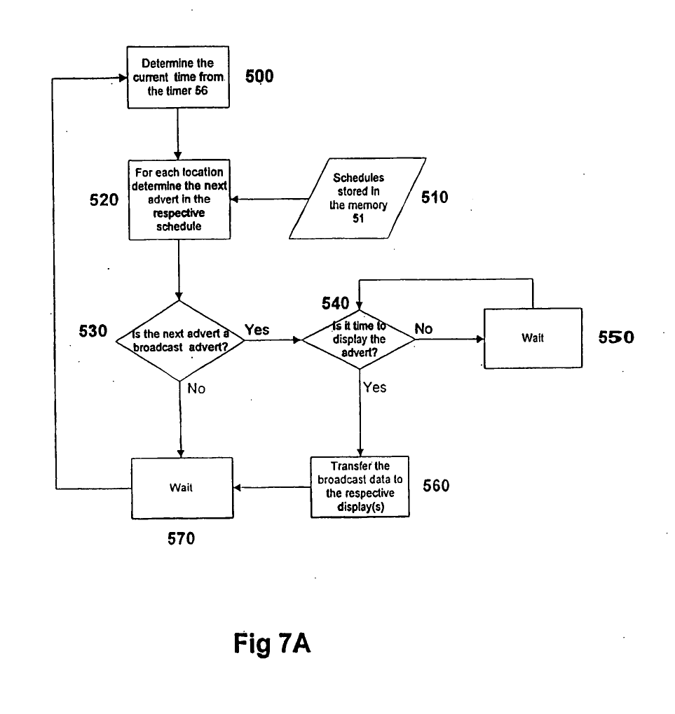

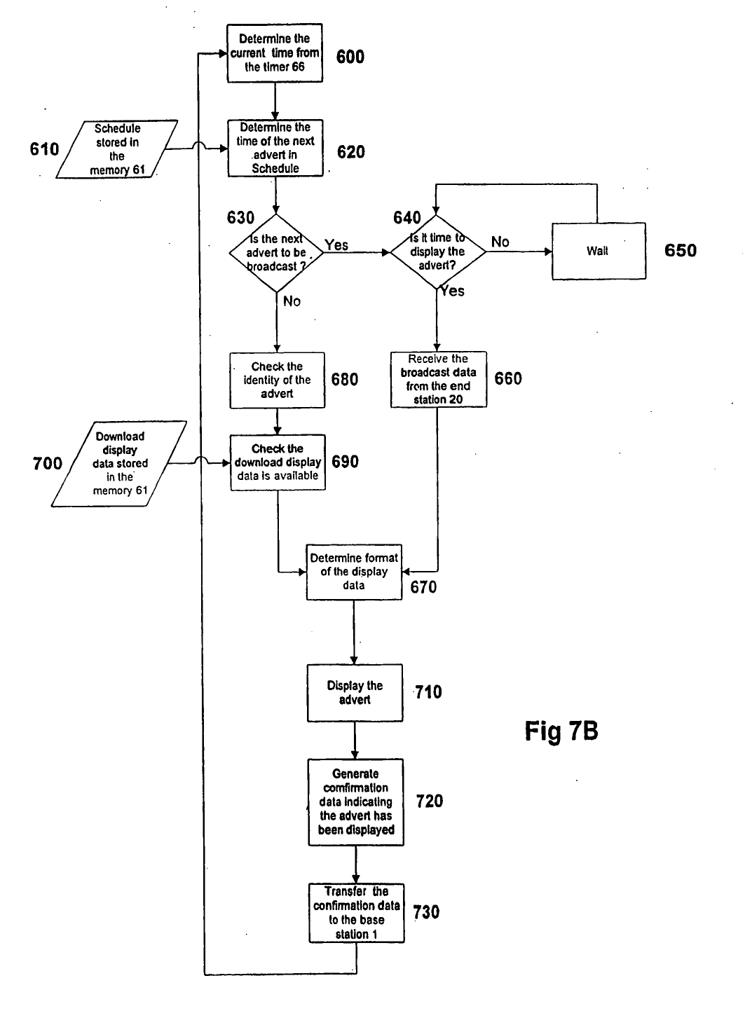

FIGS. 7A and 7B show the operation of the end station 20 and the displays 23 in the static mode of operation.

Firstly, as shown in FIG. 7A, at step 500, the processor 50 of the end station 20 operates to determine the current time from the timer 56. The timer 56, as well as the timers 66 in the displays 23, is synchronised with the timer 46 in the server 10 using the SNTP protocol. This synchronisation is performed at predetermined time intervals, for example every 12 or 24 hours, as defined within the system programming.

Following this the processor 50 accesses each of the schedules stored in the memory 51, including the broadcast schedule, to determine the next advert to be displayed at each location, as shown steps 510 and 520 respectively.

In the case where a broadcast advert is to be displayed, the processor 50 confirms whether the current time is the time at which the advert should be displayed, based on the determined schedule, as shown at step 540. If the time is not yet the correct time, the processor 50 waits as shown at step 550 until the advert is due to be displayed, at which time the processor 56 operates to transfer the broadcast data to the respective displays 23 from the memory 51.

In order to do this, the processor 50 will determine from the broadcast schedule the display identifiers of the displays to which the broadcast data is to be transferred. The data will then be transferred as required via the transceiver using the techniques outlined above.

Following the transfer of the broadcast data, or upon the determination that the next advert is a download advert, the processor 50 is adapted to wait for a predetermined amount of time at step 570 before determining the time again at step 500.

It will be appreciated from this that in the case of download adverts, as the adverts have already been transferred to the displays 23 then no further action is required by end station 20 at this time.

Operation of the displays 23 will now be described with reference to FIG. 7B.

Firstly, as shown at step 600, the processor 60 of the display 23 operates to determine the current time from the timer 66. Again, the timer 66 is synchronised with the timer 46 in the server 10 using the SNTP protocol.

As shown at step 610, the processor 60 accesses the schedule stored in the memory 61 and uses this to determine the time of the next advert in the schedule at step 620.

The processor 60 then determines at step 630 whether this next advert is a broadcast advert or a download advert.

In the case in which the advert is a broadcast advert, the processor 60 determines if the current time is time to display the advert at 640. If not, the processor waits at 650 until it is time to display the advert, at which time the processor 60 will begin to receive broadcast data from the end station at step 660.

As the data is received the processor 60 operates to determine the format of the broadcast data at step 670 before displaying the advert, as will be described in more detail below.

On the other hand, if the next advert is a download advert, the processor 60 will check the identity of the next advert at step 680 before checking that the corresponding display data is available in the memory 61, as shown at steps 690 and 700. Having obtained the download display data from the memory 61 at step 690, the processor 60 will operate to determine the format of the display as shown at 670.

In order to determine the format of the advert, the processor 60 will execute applications software which is capable of analysing the received data and determining the format of the data. In particular, the processor 60 will determine if the data represents TV, audio and/or video signals, or whether the data is a computer type file, such as an MPEG data, Flash data, Macromedia data, Shockwave data, or the like.

Having determined the format of the data, the processor 60 operates to display the advert as shown at step 710.

In order to do this, the processor 60 operates application software stored in the memory 61 which is capable of displaying all these formats data. In order to do this, the applications software combined players of the respective format within a single application. The processor 60 selects the desired player and then operates to play the data.

Accordingly, unlike current displays in which it is usually necessary to convert the format of the data to a predetermined format, the displays 23 of the current system are therefore able to receive and play data in almost any format without the need to convert the data. This in turn saves time and processing in the display of the adverts.

After displaying the adverts, the processor 60 generates confirmation data at step 720 indicating that the advert has been displayed, together with details of the time at which the advert was displayed, the location and how long the advert was displayed for. This information is then transferred back to base station 1 via the end station at step 730, for reasons that will be explained in more detail below.

At this time, the display is ready to display another advert and accordingly returns to determining the current time at step 600.

It will be appreciated that typically, the processor 60 can return to step 600 to determine the next advert to be displayed whilst the previous advert is still being displayed. This ensures that the next advert is ready for display before the previous advert finishes. In this case, the confirmation data relating to an advert may be generated and transferred to the base station 1 whilst the next advert is being displayed.

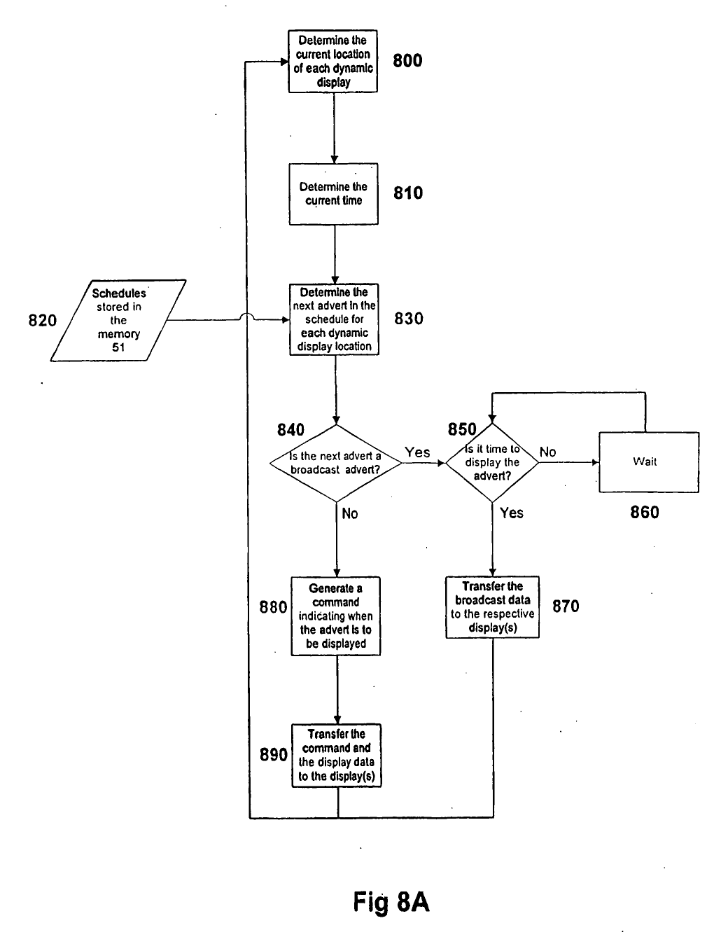

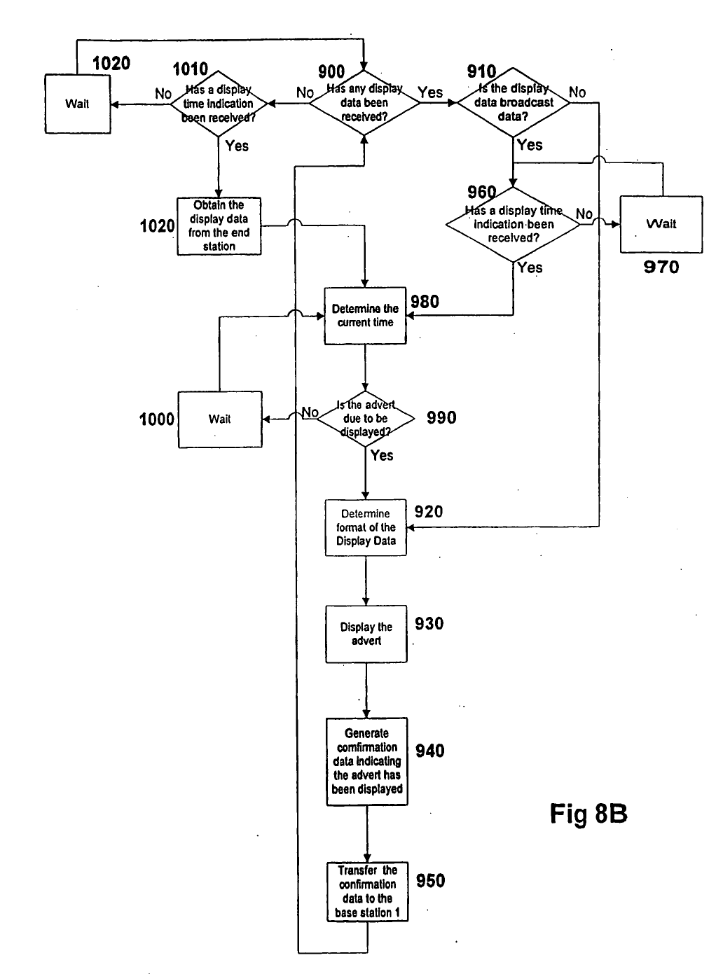

Turning now to dynamic operation, this is described in FIGS. 8A and 8B.

FIG. 8A indicates that initially at step 800 the processor 50 of the end station 1 operates to determine the current location of each dynamic display. This can be achieved in a number of different manner depending on the implementation of the display system.

Thus, for example, the displays could have devices, such as GPS devices, which operate to determine the current location of the device, returning an indication of this to the end station 20. Alternatively, the end station may use a number of antennas coupled to the transceiver. In this case, the relative signal strength of signals obtained from the displays would be used to determine the display positions. In addition to these techniques, it is also possible to place additional sensors, such as inductive sensors in the supermarket, which are capable of tracking the displays, or the trolleys to which the displays are mounted, as they move around the store.

At step 810 the end station processor 50 then operates to determine the current time from the timer 56, before accessing the schedules stored in the memory 51 as shown at steps 820 and 830.

As mentioned above, the schedules indicate for each location the advert that is to be displayed. Accordingly, the processor 50 is adapted to select appropriate schedules based on the current locations of the dynamic displays.

From these selected schedules, the processor 60 is able to determine the next advert to be displayed on each dynamic display at each of the respective locations. Thus, as will be appreciated by a person skilled in the art, the next advert to be displayed on a dynamic display is selected based on the current display location.

At step 840 the processor determines whether the next advert is a broadcast advert. If the advert is a broadcast advert the processor then determines whether it is time to display the advert at step 850. This can be achieved either from the schedule for the respective location, or from the broadcast schedule. If it is not yet time to display the advert, the processor 50 waits at step 860 before transferring the broadcast data to the respective displays at the appropriate time at step 870.

Alternatively, in the case in which the advert is a download advert, the processor 50 generates a command indicating when the advert is to be displayed at 880. The processor 60 then transfers the command together with the respective display data to the respective displays 23 as required. This is the reason why download display data must be retained in the memory 51 even when it has been transferred to each of the static displays as required.

It will be appreciated from this, that this allows the end station 20 to transfer data to the displays dependent on the current display location. Accordingly, this technique can advantageously be used to ensure that adverts are directed at the products a customer is currently walking past with their shopping trolley, thereby increasing the relevance of the advert to the customer.

In this mode of operation, operation of the displays is as shown in FIG. 8B.

As shown the display processor 60 begins at step 900 to determine whether any display data has been received.

If the display data has been received. The processor 60 operates to determine if this is broadcast data at step 910. In the event that it is broadcast data then the processor 60 moves on to step 920 to determine the format of display data, before displaying the respective advert at 930, in a similar manner to the technique outlined above with respect to the static displays. Once the advert has been displayed, the processor 60 generates confirmation data indicating that the advert has been displayed at step 940 and transfers this confirmation data to the base station at step 950.

In contrast, if the display data is download data, the processor operates to determine whether the command indicating the display time has been received at step 960. If not the processor simply waits and continues checking until the command is received, as shown at step 970.

Once the command has been received, the processor operates to determine the current time at step 980 and then determine whether the advert is due to be displayed yet. If the advert is not due to be displayed the processor 60 waits at step 1000 before checking the current time again at step 980.

When the advert is due to be displayed the processor 60 operates to determine the format of the display data at 920 before operating to display the data as described above.

Finally, in the event that the display data is not received when the processor initially checks at step 900, the processor operates to determine whether a command indicating a display time has been received at step 1010.

If not, at step 1020 the processor waits before again checking whether display data has been received at step 900. Otherwise the processor operates to receive the download display data from the end station at step 1020 before determining the current time at step 980.

It will therefore be appreciated by the skilled man that in addition to receive download data and broadcast data, the displays are also adapted to operate either as static displays or as moving displays.

In the case of the static displays, the adverts to be displayed are determined for each respective display in advance. The adverts are then displayed in accordance with a schedule stored at the display itself. It will be appreciated that this system has the benefit that scheduling the adverts in advance means that any short duration failure in the communications system will not prevent adverts already scheduled from being displayed.

Accordingly, the system can be adapted to do most of the data transfers at night when the cost of leasing communications lines is lower, with the adverts being stored on the displays for display during the subsequent day.

In contrast, in the case of the dynamic displays, no schedules are required at display because the next advert to be displayed is selected in accordance with the current location of the display.

Instead, the end station 20 maintains a schedule for each location and then simply select the respective schedule depending on the current location of each dynamic display.

As described above, once an advert has been displayed, confirmation data indicative of this is generated by the display and transferred to the base station 20 via the radio transceiver 22. This confirmation data is then transferred via the communications network 2 to the base station.

Once received by the base station 1, the confirmation data is transferred via the switch 12 to one of the controllers 11. The controller 11 stores the confirmation data in an advertising transaction log in the memory 51.

The advertising transaction log indicates for each advertiser the advertising which has been performed. This is then used by the controller together with information about the advertiser stored in a separate customer information database and a pricing structure stored in a separate pricing database to generate an invoice.

The invoice is generated based on the adverts that have been displayed allowing the advertiser to be confident that they are not paying money for adverts that have not actually been displayed to the public. It will be appreciated by a person skilled in the art that the billing system can also be used to monthly sales report and the like as well as analysing payment of bills.

In addition to the above, a number of other features are also utilised by the invention.

The system is implemented using object oriented programming languages such as C++, Microsoft Visual Basic, SQL, etc . . . and integrating the modules as a single system. Standard communication protocols are used to make the system widely accepted and easy to deploy.

In particular, the system uses the following modules, implemented as applications software by the server 10.

Transmission and control module

The Transmission and control module is for management purpose. Transmission of data packets form end-to-end can be monitored and managed from the headquarters. TCP/IP set of protocols is the standard communication protocol for data communication within the entire system. Information of contents being displayed on any individual can be received at any control display within the system.

Planning module

The planning module helps plan the operation and includes information concerning the following:

Size of the site

Location

Number of displays to be placed

Size of the displays

Amount of radio-antennas and transceivers/base-stations required

Calculates the bandwidth required for a successful real-time communication.

All this information is used to help plan the operation in advance for a successful deployment of the system. It also helps us to troubleshoot any further problems while deployment or in future.

Communications Module

The communication module keeps track of processes running in the entire system and ensures that content is received and displayed as planned and scheduled. In case of a failure it automatically runs a fall-back option and immediately generates an alert at the base station.

Marketing

The marketing module has standard marketing tools, which is useful for the marketing team.

Preferably the system uses specific ports to listen and send encrypted data. Thus the system uses pre-defined specific ports, which are secured to transmit and receive data. This helps improve the communication speeds, as well as reliability and security.

In this case, the ports are predefined in the entire system.

Accordingly, individual port numbers can be used for different types of data and since multi-threaded communication is designed in every stage, multiple information arrives simultaneously.

Furthermore, the displays include the following features:

Smart: The displays are built with integrated microprocessors and can be used as a stand-alone computer.

Wireless: The display device uses integrated radio transceiver and antenna designed for the ISM band. The antenna is in-built invisibly within the frame of the display device. The display device is capable of communicating at speeds up to 11-Mbps with other wireless display or with a base station/access-point.

Ruggedised: The device is ruggedised and is tested to work in various in-house and commercial environments.

Fire-Proof: The Display glass and frame of the displays are made of fire-proof materials and are tested for burning fire. They are capable of working on a very high temperature.

Low-Power: The device's power consumption is quite low in comparison to other similar devices available in the market.

Interactive: The display devices are designed with inbuilt touch-screen capability which makes them a complete interactive and smart device. By using touch-screens, a few touches on the screen gives a user access to directory services and other useful information.

High-Resolution: The display supports XGA format video with 32 bit colors, which makes it a true color display capable of showing millions of colors.

Wide-Screen: The displays are of different sizes. From 15 inches to 50 inches in size for different sites and locations.

Light-Weight: The displays are very light in weight because they are build with LCD screens. The interior components are integrated on a PCB board and are quite small and light in weight.

Finally the system preferably uses a special communication protocol that is used to tie up all the objects and components (software and hardware) to form up a complete end-to-end solution for the system.

The protocol ties up all the internal components and devices and makes them work as one system. The protocol is a combination of all other standard protocols and applications. The algorithm in which the protocol functions, is defined in the entire system at every point. The system described above advantageously uses a real-time multitasking operating system to perform the functionality described above. In this case, the operating system is a full-featured real-time multitasking operating system designed for high performance embedded system and PC applications.

In this example, the operating system is based on an object-oriented design, which allows the system to provide improved performance and functionality. In order to achieve this the operating system preferably provides a number of features, including:

Inter-operability with other operating systems and in particular with Microsoft Windows environment;

Strong networking and security components built-in;

High-resolution graphics;

Wireless and complete wireless (next-generation ready);

Ease of enhancement.

The operating system is formed from a number of components, each of which is specified as a respective object. Accordingly, at any instant in time, the operating system can be considered as a number of interacting objects. The operating system allows an unlimited number of objects to be created and destroyed dynamically at run time and there is no need to statically configure objects.

This allows the system to be operated with increased control, management, resource usage adaptability and security, as well as allowing the operating system to build high performance object oriented real-time multitasking applications. Accordingly, the operating system allows applications to be created and tested in real-time.

The major objects implemented within the operating system will now be described.

Task Object—controls the operation of executable code provided by the user

Timer Object—controls timer operation

Semaphore Object—controls semaphore operation

Message Box Object—controls message box operation

Event Object—controls event operation

Queue Object—controls queue operation

Buffer Object—controls buffer operation

Fixed Size Memory Object—controls fixed size memory operation

List Object—controls list operation

Device Object—controls device operation

In general the OS can create an unlimited number of respective objects as required. Respective data and methods are used to define the manner in which each object should function, with each object type being referenced by a respective pointer.

The use of these objects allows the OS to implement a wide range of operations. These include:

Preemptive Prioritized Task Scheduler

Task scheduling, including the scheduling of information display, is handled by purpose built scheduler that generally provides the following capabilities:

Dynamic Task Management

This allows task objects to be created, deleted, and prioritized dynamically. No static task configuration is required and an unlimited number of task objects can be created.

Task Constructor and Destructor

The operating system allows tasks to be written as objects, with the same task code can be used to handle multiple state machines as follows:

A task constructor is initiated prior to executing the body of the task. Task data is allocated and objects needed by the task are created, devices are opened, state variables are Initialized, and state machines synchronized.

Upon return from the task constructor the task main body is run until the task returns or is deleted.

Upon task completion or deletion, the task destructor is executed. Here memory is freed, objects are destroyed, state machines terminated.

Timers

Timer objects are handled with an advanced delta timer list mechanism that reduces timer interrupt latency to an absolute minimum. Timers can be one-shot or continuous and can schedule a specified task upon timeout

Bit Mapped Events

Event objects allow tasks and interrupt handlers to signal each other through bit mapped events.

Events can be specified as maskable or non-maskable and optionally schedule a specified task upon event posting.

Inter-Process Communication (IPC)

IPC is handled through message boxes. IPC allow tasks and interrupt service routine to send and receive messages containing pointers to blocks of data to and from message boxes. IPC has fast no-copy message passing, list style message box management, optional task schedule upon message arrival, and message memory management.

Counting & Mutex Semaphores

Counting semaphores follow the industry standard “up/down” mechanism Semaphores can be used for mutual exclusion by setting the initial count to a value of one. Semaphore down operations can be specified as blocking, non-blocking, or timeout when the semaphore count is zero. Priority inversion is handled with an option for priority inheritance.

Data Queues

Data queues are forward linked lists of data in a FIFO queue. Queues are typically used for I/O in block device drivers or for moving block data between processes.

Data Buffers

Data buffers are FIFO circular buffers of characters. Buffers are typically used for I/O in character device drivers and for moving character data between processes.

Data Lists

Data lists are doubly linked lists of block data and are used for managing lists of data in either FIFO or LIFO queues. Data list management offers a fast and efficient mechanism to perform complex data handling within a process or between processes.

Fixed Size Memory Management

Fixed size memory management allows for the fast and unfragmented allocation and deallocation of blocks of fixed size memory.

Variable Size Memory Management

Variable size memory management uses malloc and free wrapped around mutex semaphore operations to protect non-reentrant nature of these calls.

Device Interface

The operating system device interface offers a way for processes to use common I/O calls for an unlimited number of devices. Both character and block 110 is provided for and the Interface is an industry standard device driver call set.

Interrupt Handling

Interrupts service routines can make operating systems calls and schedule tasks by including ENTER_ISR and EXIT_ISR macros at the beginning and end of the ISR. Most operating system services are available to interrupt service routines thus giving ISRs considerable processing capability.

Critical Section Handling

Critical section handling is very important in real-time systems. Non-reentrant code sections must be protected from both interrupt and task preemption. Interrupt preemption protection is offered with recursive interrupt disable and enable calls. Task preemption protection is offered with recursive task scheduler lock and unlock calls. Task preemption can also be prevented for a specified priority level with dynamic task prioritization.

Task Execution Trace

Each task has its own trace buffer, which is both compile time and run time controllable. The user specifies the depth of the trace buffer and can dynamically control tracing throughout the task thread. The trace buffer contains information about the sequence of calls, the parameters passed, and the return value of the called function.

Scalability

The operating system is both code and data scalable. Code modules are highly granular and placed in a linkable library so that only the modules used get placed into your application. Data scalability is provided for in header files that allow the user to set certain data types to fit their applications.

The system describes above uses a client/server operation model. Accordingly, the operating system must be adapted to operate both as a server and as a client. The site server will be installed on every site to serve all clients in that particular site. In order to achieve this the operating system is preferably capable of the following functionality:

Multitasking

Reliability

Capable of operating with minimum downtime in any environment

TCP/IP, FTP and Telnet capabilities

Remote management and administration

DNS Server

Task scheduling

Backup and disaster recovery

Server functionality, including RADIUS, Syslog, Database and Multimedia capabilities

UPS protection

Time synchronization

Robust and high security

The clients are installed in particular site areas. In general the clients require similar functionality to that described above with respect to the servers, with the clients also providing multimedia service and playback capabilities, as well as log generation.

As will be appreciated from the above, besides the advertisement industry, the system is very useful in other fields of business as well, such as:

a) Warehousing, transportation and logistics business. For example, the interactive mobile-display can be mounted on a forklift in a warehousing atmosphere, which will bring location specific data on a real-time basis to the display and this will help the worker on the forklift to travel less and be more productive.

b) Hospitals. For example, the interactive mobile-display can be mounted on beds and on trolleys in the hospital wards, and when the mobile-display is moved from patent to patent the interactive display automatically brings the patients profile on the screen without even touching a single button.

c) Production factories. For example the mobile-display can be either mounted on a trolley or on a vehicle inside the premises where the supervisor working with the device can be updated automatically, with his job file and he can transmit date relevant to his area of work on a real-time basis. The system can be very helpful to supervisors and persons concerned with quality management.

It will be appreciated by persons skilled in the art that numerous variations and modifications will become apparent. All such variations and modifications which become apparent to persons skilled in the art, should be considered to fall within the spirit and scope of the invention as broadly hereinbefore described.

The claims defining the invention are as follows:

1) A system for displaying information at a remote site, the system including:
a) A display system positioned at the remote site, the display system including:
i) An end station; and,
ii) A number of displays, the number of displays being adapted for wireless communication with the end station;
b) A base station including:
i) An input for receiving display data representing the information to be displayed; and,
ii) A controller for controlling the display of the information; and,
c) A communications system for transferring the display data from the base station to the display system, the display system being adapted to display the information as required by the controller.

2) A system according to claim 1, each display including:
a) A display store for storing display data;
b) A screen; and,
c) A display processor, the display processor being adapted to cause the screen to display the information represented by the display data.

3) A system according to claim 1 or claim 2, the end station including:
a) An end station store for storing display data received from the base station; and,
b) An end station processor, the end station processor being adapted to control the transfer of the display data to the displays.

4) A system according to any of claims 1 to 3, the information having one of a number of different types, the information type being indicated in the corresponding display data.

5) A system according to claim 4, the controller including:
a) A control store for storing location data, the location data indicating a location for each display at the remote site; and,
b) A control processor, the control processor being adapted to:
i) Determine the information type of the respective information to be displayed;
ii) Determine the location in which the respective information is to be displayed, the location being determined in accordance with the information type;
iii) Schedule the display of the respective information at the respective location; and,
iv) Transfer the corresponding display data to the display system.

6) A system according to claim 5, wherein display system is adapted to maintain a schedule for each location, the display system being adapted to display the respective information in accordance with the respective schedule.

7) A system according to claim 6, wherein the control processor is adapted to transfer the schedules to the display system by transferring commands, each command indicating the time and the location(s) at which the respective information is to be displayed.

8) A system according to claim 7, wherein at least some of the displays are statically positioned at the remote location, each static display being adapted to maintain a respective schedule.

9) A system according to claim 8, when dependent on claim 2, wherein the end station is adapted to transfer the commands to the static display(s) in accordance with the display location(s), the display processor of each static display being responsive to the commands to maintain the respective schedule.

10) A system according to claim 9, when dependent on claim 3, wherein if the display data is broadcast data adapted to be broadcast from the end station, the end station processor is adapted to:
a) Maintain a broadcast schedule for each location, the broadcast schedule indicating the time at which the respective information is to be displayed; and,
b) Transfer the broadcast data to one or more of the displays positioned in the respective location in accordance with the respective schedule.

11) A system according to claim 10, wherein the end station processor is adapted to maintain the broadcast schedules by:
a) Determining the commands which relate to information for which the corresponding display data is broadcast data; and,
b) Either updating existing broadcast schedules or generating new broadcast schedules.

12) A system according to claim 10 or claim 11, wherein the display processors are adapted to:
a) Receive the broadcast data; and,
b) Cause the corresponding respective information to be displayed on the screen in accordance with the respective schedule.

13) A system according to any of claims 9 to 12, the display processors being adapted to maintain a schedule by:
a) Receiving the commands; and,
b) Either updating existing schedules or generating new schedules.

14) A system according to any of claims 9 to 13, wherein if the display data is down-load data adapted to be down-loaded from the end station prior to display, the display processor is adapted to maintain the respective schedule by:
i) Receiving the commands;
ii) Determining the respective information to which the command refers;
iii) Determining if the display data corresponding to the respective information is stored in the display store; and,
iv) Either updating existing schedules or generating new schedules in response to a successful determination.

15) A system-according to claim 14, wherein in response to an unsuccessful determination the display processor is adapted to generate a request for the corresponding display data, the end station being responsive to the request to transfer the corresponding display data to the display store.

16) A system according to claim 15, the display processor being adapted to either updating existing schedules or generating new schedules upon receipt of the corresponding display data.

17) A system according to at least claim 7, wherein at least some of the displays are dynamically positioned at the remote location, each dynamic display being moved between different locations in use

18) A system according to claim 17, when dependent on claim 3, the end station processor being adapted to:
a) Receive the commands;
b) Maintain a schedule for each location in accordance with the received commands;
c) Determine the current location of each dynamic display; and,
d) Transfer display data to each dynamic display in accordance with the determined location and the respective schedule.

19) A system according to claim 18, when dependent on claim 2, wherein the display processors are adapted to:
a) Receive the display data; and,
b) Cause the corresponding respective information to be displayed on the screen.

20) A system according to any of claims 5 to 19, the input being adapted to receive a time slot notification indicating when the respective information is to be displayed, the controller being adapted to schedule the display of the respective information in accordance with the time slot notification.

21) A system according to any of claims 4 to 20, the information including adverts, the information type indicating the type of product being advertised.

22) A system according to any of claim 21, when dependent on claim 5, wherein the location data specifies the types of products near which the display is located.

23) A system according to any of claims 2 to 22, wherein the display processors are adapted to display data having any one of a number of different formats.

24) A system according to any of the preceding claims, the base station being adapted to encrypt the display data prior to transfer to the display system, the end station being adapted to decrypt the encrypted display data.

25) A system according to any of the preceding claims, the base station being adapted to compress the display data prior to transfer to the display system, the end station being adapted to decompress the compressed display data.

26) A system according to any of the preceding claims, the base station including a billing system, the billing system being adapted to generate a bill for displaying the information.

27) A system according to claim 26, wherein each display is adapted to generate confirmation data confirming the display of the respective information, the confirmation data being used by the billing system to generate the bills.

28) A system according to any of the preceding claims, wherein the communications system includes a communications network that interconnects the end station and the base station.

29) A display for displaying information provided by an end station, the display including:
a) A transceiver for providing wireless communication with the end station, the transceiver being adapted to receive:
i) Display data representing the information to be displayed; and,
ii) An indication of the time at which the respective information is to be displayed;
b) A display store for storing display data;
c) A screen;
d) A display processor adapted to cause the screen to display the respective information at the indicated time.

30) A display according to claim 29, the display including a timer, the display processor being responsive to the timer to display the respective information at the indicated time.

31) A display according to claim 29 or claim 30, the display being adapted to display information corresponding to display data having any one of a number of formats.

32) A display according to claim 31, the number of formats including.
a) Video;
b) Audio;
c) Graphics;
d) Multimedia; and,
e) Text.

33) A display according to any of claims 29 to 32, wherein if the display data is broadcast data adapted to be broadcast from the end station, the display processor is adapted to display the respective information as the broadcast data is received.

34) A display according to any of claims 29 to 33, wherein the transceiver is adapted to receive commands, each command indicating the time at which the respective information is to be displayed, the display processor being adapted to:
a) Use the commands to maintain a respective schedule indicating the time at which information is to be displayed; and,
b) Display the information in accordance with the respective schedule.

35) A display according to any of claims 29 to 34, wherein the display includes an input, the display data representing interactive information, the display processor causing the display data to interact in response to commands received at the input.

36) A display according to claim 35, wherein the input includes a touch sensitive screen.

37) A display according to any of claims 29 to 36, the display processor being adapted to generate confirmation data confirming the information which has been displayed, the confirmation data being transferred to the end station.

38) A computer program product for use in a display system for displaying information provided by an end station, the computer program product including computer executable code, the computer executable code being adapted to cause a display having suitably programmed processor display the respective information at the indicated time.

39) A computer program product according to claim 38, the computer executable code being adapted to cause the display to operate as a display according to any of claims 29 to 37.

40) An end station for use in a display system, the display system being adapted to display information at a remote location, the end station including:
a) An input for receiving:
i) Display data representing the information to be displayed; and,
ii) An indication of the time and location at which the respective information is to be displayed; and,
b) An end station store for storing display data; and,
c) An end station processor, the end station processor being adapted to control the transfer of the display data to one or more of a number of displays, the respective information being displayed on the displays.

41) An end station according to claim 40, the end station processor being adapted to transfer the display data to the displays via a transceiver.

42) An end station according to claim 40 or claim 41, the end station being adapted to determine the location of each display.

43) An end station according to claim 42, wherein the end station is coupled via the transceiver to at least two antennas, the end station processor being adapted to determine the location of each display in accordance with signals received from the respective display, via each antenna.

44) An end station according to any of claims 40 to 43, the end station being adapted to receive commands, each command indicating the time and the location(s) at which the respective information is to be displayed.

45) An end station according to claim 44, wherein at least some of the display data is broadcast data adapted to be broadcast from the end station, the end station processor is adapted to:
a) Maintain a broadcast schedule for each location, the broadcast schedule indicating the time at which the respective information is to be displayed; and,
b) Transfer the broadcast data to one or more of the displays positioned in the respective location in accordance with the respective schedule.

46) An end station according to claim 45, wherein the end station processor is adapted to maintain the broadcast schedules by:
a) Determining the commands which relate to information for which the corresponding display data is broadcast data; and,
b) By either updating existing broadcast schedules or generating new broadcast schedules.

47) An end station according to any of claims 44 to 46, wherein at least some of the displays are static displays statically positioned at a location, the end station processor being adapted to transfer commands to the displays in accordance with the location of the display and the location(s) indicated in the commands.

48) An end station according to any of claims 44 to 47, wherein at least some of the displays are dynamically positioned at the remote location, each dynamic display being moved between different locations in use, the end station processor being adapted to:
a) Receive the commands;
b) Maintain a schedule for each location in accordance with the received commands;
c) Determine the current location of each dynamic display; and,
d) Transfer display data to each dynamic display in accordance with the determined location and the respective schedule.

49) An end station according to any of claims 40 to 48, wherein the received display data is compressed, the end station processor being further adapted to decompress the display data.

50) An end station according to any of claims 40 to 49, wherein the received display data is encrypted, the end station processor being further adapted to decrypt the display data.

51) A computer program product for use in a display system, the display system being adapted to display information at a remote location, the computer program product including computer executable code, the computer executable code being adapted to cause an end station having a suitably programmed processor to control the transfer of display data to one or more of a number of displays, the respective information being displayed on the displays.

52) A computer program product according to claim 51, the computer program product being adapted to cause the end station to operate as an end station according to any of claims 40 to 50.

53) A display system for displaying information at a remote location, the display system including:
a) An end station including:
i) An input for receiving:
(1) Display data representing the information to be displayed; and,
(2) An indication of the time and location at which the respective information is to be displayed; and,
ii) An end station store for storing display data; and,
iii) An end station processor, the end station processor being adapted to control the transfer of the display data to the displays.
b) A number of displays, each display including:
i) A display store for storing the display data;
ii) A screen; and,
iii) A processor adapted to cause the screen to display the information represented by the display data; and,
c) A wireless communications system for interconnecting the end station and each display.

54) A display system according to claim 53, the wireless communications system including:
a) A transceiver coupled to the end station; and,
b) Respective display transceivers located in each display.

55) A display system according to claim 53 or claim 54, the display system including an end station according to any of claims 40 to 50.

56) A display system according to any of claims 53 to 55, the display system including a number of displays, each display being a display according to any of claims 29 to 37.

57) A base station for receiving information to be displayed on a display system at a remote location, the base station including:
a) An input for receiving display data representing the information to be displayed;
b) A controller for controlling the display of the information; and,
c) An output for transferring the data and the schedule to the remote location.

58) A base station according to claim 57, the information having one of a number of different types, the information type being indicated in the corresponding display data, the controller including:
a) A control store for storing location data, the location data indicating a location for each display at the remote site; and,
b) A control processor, the control processor being adapted to:
i) Determine the information type of the respective information to be displayed;
ii) Determine the location in which the respective information is to be displayed, the location being determined in accordance with the information type;
iii) Schedule the display of the respective information at the respective location; and,
iv) Transfer the corresponding display data to the display system.

59) A base station according to claim 57 or claim 58, the input being adapted to receive a time slot notification indicating when the respective information is to be displayed, the controller being adapted to schedule the display of the respective information in accordance with the time slot notification.

60) A base station system according to claim 59, wherein the control processor is adapted to transfer the schedules to the display system by transferring commands, each command indicating the time and the location(s) at which the respective information is to be displayed.

61) A base station according to any of claims 57 to 60, wherein the input is coupled to a communications network, the input being adapted to receive the display data in an electronic format.

62) A base station according to any of claims 57 to 61, wherein the base station includes a billing system adapted to generate a bill for displaying the information.

63) A base station according to claim 62, wherein the base station is adapted to receive confirmation data from the display system, the confirmation data confirming the display of the respective information, the confirmation data being used by the billing system to generate the bills.

64) A computer program product-for use in a base station for receiving information to be displayed on a display system at a remote location, the computer program product including computer executable code, the computer executable code being adapted to cause a suitable programmed processor to:
i) Determine the information type of the respective information to be displayed;
ii) Determine the location in which the respective information is to be displayed, the location being determined in accordance with the information type;
iii) Schedule the display of the respective information at the respective location; and,
iv) Transfer the corresponding display data to the display system.

65) A computer program product according to claim 64, the computer program product causing the base station to operate as a base station according to any of claims 57 to 63.

66) A system according to any of claims 1 to 28, wherein the display system is a display system according to any of claims 53 to 56.

67) A system according to any of claims 1 to 28, wherein the base station is a base station according to any of claims 57 to 63.
